(19) United States
(12) Patent Application Publication
(10) Pub. No.: US 2013/0321595 A1
(43) Pub. Date: Dec. 5, 2013

(54) THREE-DIMENSIONAL VIDEO DISPLAY APPARATUS AND THREE-DIMENSIONAL VIDEO DISPLAY METHOD

(71) Applicant: Tatsuo SAISHU, Tokyo (JP)

(72) Inventor: Tatsuo SAISHU, Tokyo (JP)

(21) Appl. No.: 13/706,777

(22) Filed: Dec. 6, 2012

(30) Foreign Application Priority Data
May 29, 2012 (JP) 2012-122145

(51) Int. Cl. H04N 13/04

(52) U.S. Cl. CPC H04N 13/04
USPC 348/51

(57) ABSTRACT

A three-dimensional video display apparatus according to an embodiment includes: a display unit having pixels arranged in a matrix form along a first direction and a second direction perpendicular to the first direction, each of the pixels being divided into M (≧1) sub-pixels respectively having M color components arranged in the first direction; an optical control element functioning as a plurality of optical apertures extended in a straight line manner at a constant angle from the second direction; and a driving circuit conducting mapping of rearranging a multiple viewpoint video having a number N′ of viewpoints to a video to be output to the display unit, N′ being an integer satisfying ((M−1)/M) N−0.5≦N′<N or N<N′≦(M/(M−1)) N+0.5, N being equal to Q/B, Q and B being intervals of the optical apertures and the pixels respectively.

### CROSS-REFERENCE TO RELATED APPLICATION

This application is based upon and claims the benefit of priority from prior Japanese Patent Application No. 2012-122145 filed on May 29, 2012 in Japan, the entire contents of which are incorporated herein by reference.

### FIELD

Embodiments described herein relate generally to a three-dimensional video display apparatus and a three-dimensional video display method.

### BACKGROUND

As for a three-dimensional video display apparatus capable of conducting moving picture display, which is the so-called three-dimensional display, various schemes are known. In recent years, demands for especially a scheme which is a flat panel type and which does not need dedicated glasses or the like have increased. In the three-dimensional video display apparatus of this type, a scheme in which an optical control element for controlling light rays from a display panel and directing the light rays to a viewer is disposed immediately before the display panel (hereafter referred to as display device as well) having fixed pixel positions such as a liquid crystal display device or a plasma display device of direct view type or projection type is known.

The optical control element controls light rays to cause different images to be viewed according to the angle even in the same position on the optical control element. Specifically, when giving only the lateral parallax (horizontal disparity), a slit array or a lenticular sheet (cylindrical lens array) is used. When up-down parallax (vertical disparity) is also included, a pinhole array or a fly-eye lens array is used. Schemes using the optical control element are further classified into binocular, multiview, super multiview (super multiview condition of the multiview) and integral imaging. The basic principle of them is substantially the same as that which was invented approximately 100 years before and which have been used in stereoscopic photography.

In such a direct view type glasses-free three-dimensional video display apparatus using an optical control element such as a slit array or a lenticular sheet, moiré or color moiré is apt to occur due to interference between a periodic structure of optical apertures of the optical control element and a periodic structure of pixels on a plane display device. As a countermeasure against it, a method of inclining the extension direction of the optical apertures of the optical control element obliquely is known. However, the moiré cannot be eliminated completely by only providing the optical apertures of the optical control element with inclination. Therefore, a method of eliminating the moiré by adding a diffusion component is proposed. However, this method degrades separation of parallax information (image information which provides a view changed according to a viewing angle), degradation of the image quality cannot be avoided. If in the case where the optical apertures of the optical control element are disposed obliquely the periodicity in position relations between the optical apertures of the optical control element and the pixels of the plane display device is high, moiré is apt to occur. If the periodicity is low, moiré is hard to occur. In the case where the periodicity is low, there is a problem that processing of rearranging and disposing video data for three-dimensional video display becomes complicated and the circuit scale and required memory become large. Furthermore, mapping of rearrangement for reducing the memory is known.

In the conventional three-dimensional video display apparatus in which the optical control element is disposed obliquely, there is a problem in reconciling elimination of moiré and efficiency of image processing.

### BRIEF DESCRIPTION OF THE DRAWINGS

FIG. 1 is a perspective view schematically showing a three-dimensional video display apparatus according to an embodiment;

FIGS. 2(a) and 2(b) are perspective views schematically showing an optical control element according to an embodiment;

FIGS. 3(a) to 3(c) are schematic diagrams showing relations among an elemental image pitch Pe, a pitch Ps of apertures of an optical control element, an optical control element gap d, a viewing distance L, and a viewing width W in a three-dimensional video display apparatus according to an embodiment;

FIGS. 4(a) to 4(c) are diagrams showing methods for constructing parallax images and stereoscopic images of the one-dimensional integral imaging scheme and multiview scheme under the condition that a set of parallel light rays is provided, according to an embodiment;

FIG. 5 is a diagram showing an example of position relations between pixels and an optical control element used in an embodiment;

FIGS. 6(a) to 6(e) are diagrams showing an example of mapping in rearrangement processing from a multiple viewpoint video to an output video;

FIG. 7A is a diagram showing examples of a combination of a relation of period between pixels and the optical control element ((Q/B)/(P/A)), an angle (inclination angle) of the optical control element with respect to a pixel column direction (second direction), Q/B, the number of mapped parallaxes N′, and an original image size, which are used in a three-dimensional video display apparatus according to an embodiment, and a viewing zone, whether there is moiré, and the number of color components in each case;

FIG. 7B is a diagram showing examples of a combination of a relation of period between pixels and the optical control element ((Q/B)/(P/A)), an angle (inclination angle) of the optical control element with respect to a pixel column direction (second direction), Q/B, the number of mapped parallaxes N′, and an original image size, which are used in a three-dimensional video display apparatus according to an embodiment, and a viewing zone, whether there is moiré, and the number of color components in each case;

FIG. 8 is a diagram showing mapping of parallax number in an example 1a; and

FIG. 9 is a diagram showing mapping of parallax number in a comparative example 1a-1.

### DETAILED DESCRIPTION OF THE INVENTION

A three-dimensional video display apparatus according to an embodiment includes: a display unit having pixels arranged in a matrix form along a first direction and a second direction perpendicular to the first direction, each of the pixels being divided into M sub-pixels respectively having M color components arranged in the first direction, M being an integer of at least 1; an optical control element installed opposite to the display unit, the optical control element functioning as a plurality of optical apertures extended in a straight line manner at a constant angle from the second direction and arranged in the first direction; and a driving circuit which conducts mapping of rearranging a multiple viewpoint video having a number N′ of viewpoints to a video to be output to the display unit, N′ being an integer satisfying

((M−1)/M)N−0.5≦N′<N

or

N<N′≦(M/(M−1))N+0.5,

N being equal to Q/B, Q being an interval of the optical apertures in the second direction, and B being an interval of the pixels in the second direction.

Hereafter, a three-dimensional video display apparatus according to embodiments will be described in detail with reference to the drawings.

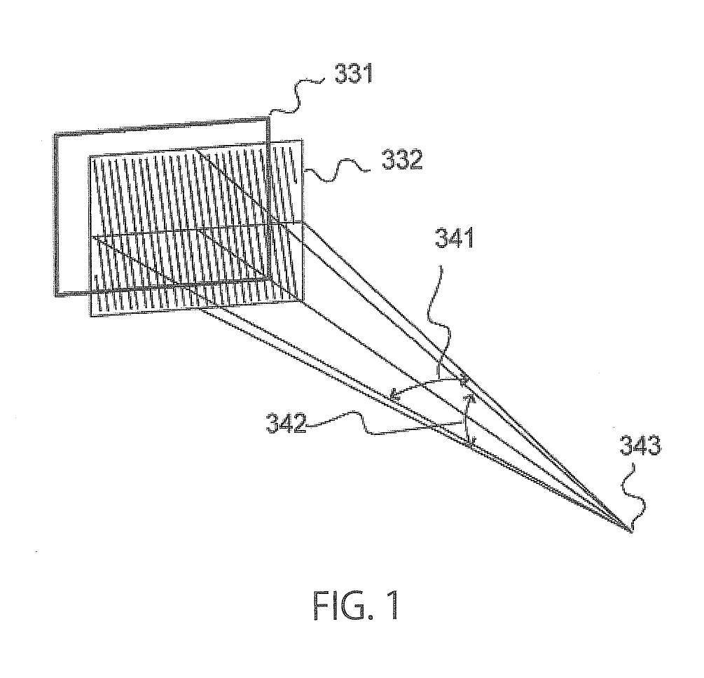

An outline of a three-dimensional video display apparatus according to embodiments will be described with reference to FIGS. 1 to 4(c). In both the integral imaging scheme and the multiview scheme, the viewing distance is usually finite and consequently a display image is produced to make a perspective projection image at that viewing distance actually viewable.

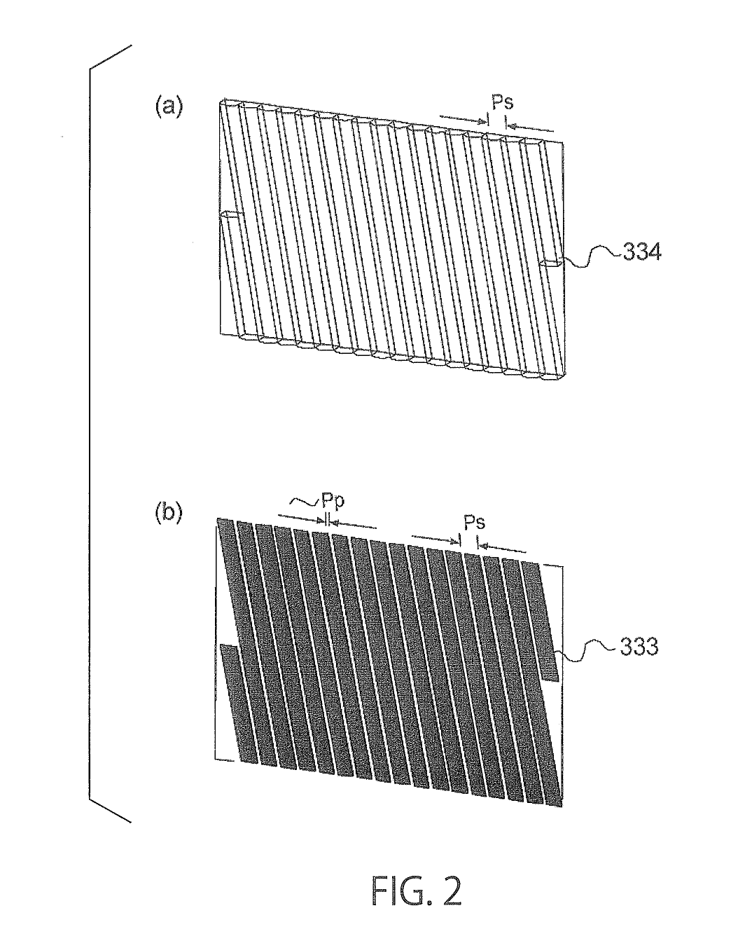

FIG. 1 is a perspective view schematically showing the whole of a three-dimensional video display apparatus according to embodiments. The display apparatus which displays a three-dimensional video shown in FIG. 1 includes a plane video display unit 331 (hereafter referred to as display unit 331 as well). An optical control element 332 which controls light rays from the display unit 331 is provided in front of the display unit 331. As the optical control element 332, there is a lenticular sheet 334 shown in FIG. 2(a), a slit array sheet 333 shown in FIG. 2(b), or an optical control element of switchable type (active type) capable of electrically turning on or off the lens effect or a slit. The optical control element 332 has optical apertures. If the optical control element 332 is the lenticular sheet 334, the optical aperture is equivalent to each cylindrical lens. If the optical control element 332 is the slit array sheet 333, the optical aperture is equivalent to each slit provided on the slit array sheet 333.

The optical apertures of the optical control element 332 substantially limits light rays from the display unit 331 directed to a viewing zone on which a three-dimensional video is displayed. The optical apertures of the optical control element 332 are provided to be associated with elemental images which constitute a two-dimensional video displayed on the display unit 331. The output video displayed on the display unit 331 is composed of as many elemental images as the number of the optical apertures of the optical control element 332. As a result, the elemental images are projected toward the space in the viewing zone respectively via the optical apertures of the optical control element 332, and consequently a three-dimensional video is displayed in front of or behind the three-dimensional video display apparatus.

Furthermore, in the embodiments described hereafter, the optical apertures are disposed with an extension direction of apertures (lenses or slits) inclined from pixel columns in the longitudinal direction of the plane video display device. By the way, in FIGS. 2(a) and 2(b), Ps is a horizontal pitch of the optical apertures. In FIG. 2(b), Pp is a width of a slit. In an optical control element of switchable type, for example, a liquid crystal layer is sandwiched between one pair of substrates and a voltage is applied between electrodes periodically arranged on a first substrate included in the pair of substrates and electrode formed on a second substrate. As a result, electric field distribution is generated in the liquid crystal layer to change the alignment of the liquid crystal layer and generate refractive index distribution which acts as a lens. In another optical control element of switchable type, polarized light which is input to a birefringent lens formed of liquid crystal is switched by another liquid crystal cell.

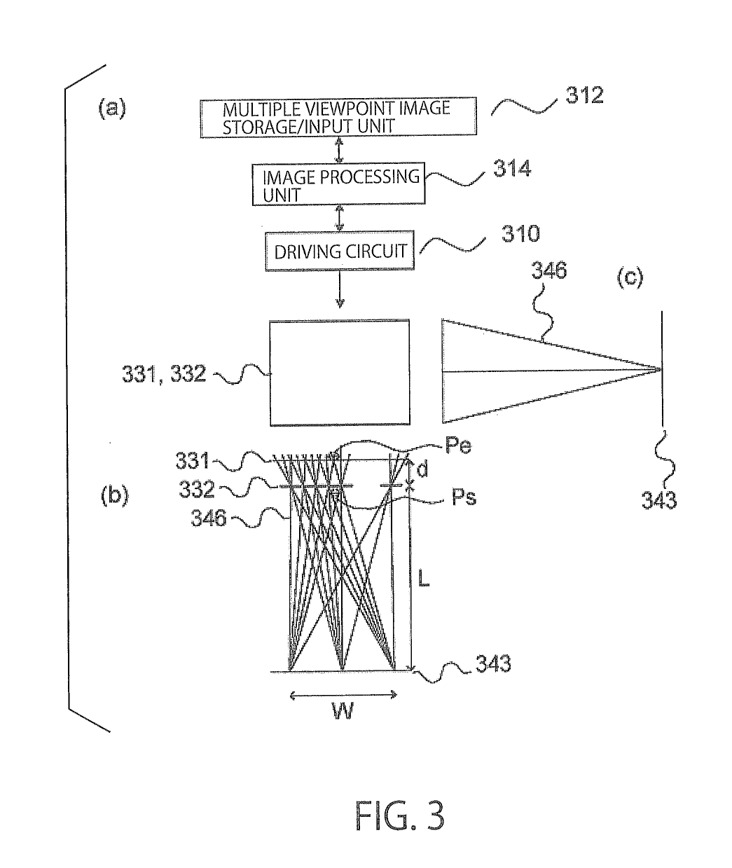

FIGS. 3(a) to 3(c) are exploded views which schematically show the whole of a three-dimensional video display apparatus. As occasion demands, a spacer (a glass substrate, a resin substrate, a film, a diffusion sheet, or a combination of them) is provided between the plane image display unit 331 and the optical control element 332. FIG. 3(a) is a front view showing a front face of the three-dimensional video display apparatus and a control unit formed of a driving circuit 310, a multiple viewpoint image storage/input unit 312, and an image processing unit 314. FIG. 3(b) is a plane view showing an image disposition in the three-dimensional video display apparatus. FIG. 3(c) is a side view of the three-dimensional video display apparatus. As shown in FIGS. 1 to 2(b), the three-dimensional video display apparatus includes the plane video display unit 331 such as a liquid crystal display element and the optical control element 332 having optical apertures.

In the three-dimensional video display apparatus, in the range of a screen viewing angle 341 in the horizontal direction and a screen viewing angle 342 in the vertical direction, it is possible to view the display unit via the optical control element 332 from an eye position and view a stereoscopic image in front of and behind the plane video display unit 331. Here, the number of pixels in the plane video display unit 331 is the number obtained when counting pixels groups each of which forms a minimum unit and takes the shape of a square. For example, the number of pixels in the lateral direction (horizontal direction) is 3,840 and the number of pixels in the longitudinal direction (vertical direction) is 2,160. It is supposed that each pixel group of the minimum unit includes red (R), green (G) and blue (B) sub pixels.

If in FIG. 3(b) a viewing distance L between the optical control element 332 and a viewing distance plane 343, a pitch Ps of the optical apertures in the optical control element in the horizontal direction, and a gap d between the optical control element and the plane video display unit are determined, then an elemental image pitch Pe is determined by an interval obtained by projecting optical aperture centers from a viewpoint on the viewing distance plane 343 onto a display plane. A reference numeral 346 denotes a line which couples the viewpoint position to a center of each optical aperture. A viewing zone width W is determined on the basis of a condition that elemental images do not overlap each other on the display plane of the display device. As already described, the elemental image is equivalent to a two-dimensional interleaved image (a part of a parallax interleaved image which is a final output video) displayed by a set of sub-pixels generating a light ray flux which is passed through a certain optical aperture of the optical control element 332 and directed to a viewing zone between the optical control element 332 and the viewing distance plane 343. A plurality of elemental images is displayed on the display unit 331 and it is projected. As a result, a three-dimensional video is displayed.

The plane video display unit 331 is driven by a display signal supplied from the drive unit 310 to display the parallax interleaved image on the plane video display unit 331. The driving circuit 310 has the multiple viewpoint image storage/input unit 312 as its peripheral device to compress a multiple viewpoint video group or a coupled image formed thereof and store or input a result as stereoscopic image data. Furthermore, the driving circuit 310 has the image processing unit 314 as its peripheral device to convert video data supplied from the multiple viewpoint image storage/input unit 312 to a parallax interleaved image and extract pixel data.

In the parallel light ray one-dimensional integral imaging scheme in which the horizontal pitch Ps of the optical apertures or its integral multiple is determined to be an integral multiple of the pixel pitch Pp, an average pitch Pe of elemental images which are determined to be associated with respective optical apertures and which contribute to display of a stereoscopic image, or its integral multiple does not become an integral multiple of the sub-pixel pitch Pp and has a fraction to become slightly greater than an integer. Also in a wide sense one-dimensional integral imaging scheme in which the horizontal pitch Ps of the optical apertures or its integral multiple is not determined to be an integral multiple of the pixel pitch Pp (a parallel light ray group is not formed), typically the average pitch Pe of elemental images or its integral multiple has a fraction which is a deviation from an integral multiple of the sub-pixel pitch Pp in the same way. On the other hand, in the multiview scheme, the average pitch Pe of elemental images or its integral multiple is determined to be an integral multiple of the sub-pixel pitch Pp.

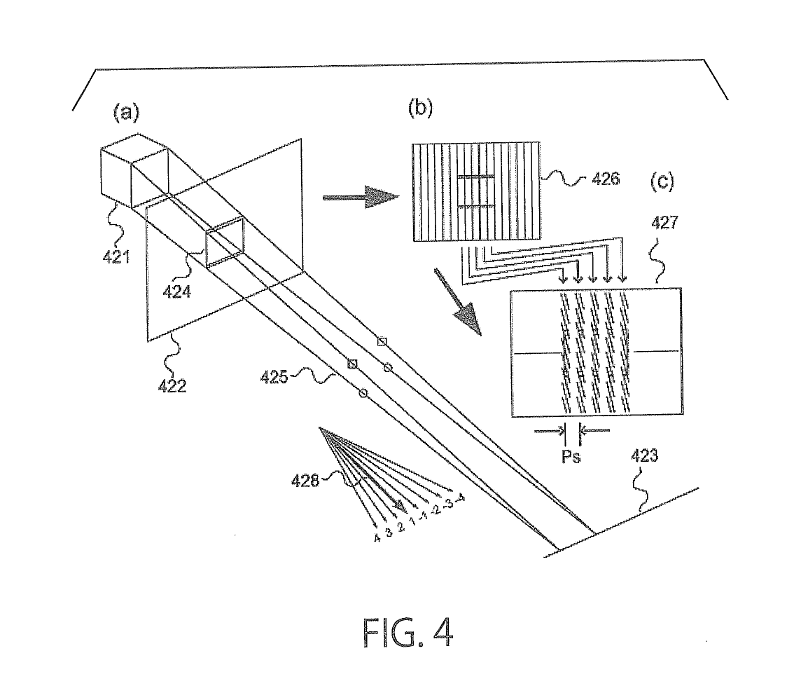

FIGS. 4(a) to 4(c) show a constitution method of a parallax image and a stereoscopic image in a one-dimensional integral scheme and the multiview scheme under the condition having a set of parallel light rays. An object (subject) 421 to be displayed is projected onto a projection plane 422 which is located in the same position as a plane on which the optical control element of the three-dimensional video display apparatus is actually located. In the one-dimensional integral imaging scheme at this time, as shown in FIG. 4(a), projection is conducted along a projection line 425 directed toward a projection center line 423 which is parallel to a projection plane, which is located on the front (center in the up-down direction), and which is in the viewing distance plane to implement perspective projection in the vertical direction and orthographic projection in the horizontal projection. The projection lines do not intersect each other in the horizontal direction. In the vertical direction, however, the projection lines intersect at the projection center line. Each projection direction is associated with a parallax number. However, the directions are not located at equal angles, but are located at equal intervals on the viewing distance plane (projection center line 423). In other words, it is equivalent to shooting by translating a camera (in a constant direction) on the projection center line at equal intervals. In the projection method in the case of multiview, perspective projection is conducted with respect to the projection center point. Reference numeral 428 denotes a direction of parallax.

By the way, no matter whether to conduct the one-dimensional integral imaging or conduct typical perspective projection in the same way as the multiview, there is substantially no problem except slight distortion is caused in the stereoscopic image. Each parallax component image 426 projected in this way is divided, every pixel column, subjected to interpolation processing as occasion demands, separated from each other at intervals corresponding to the horizontal pitch Ps of the optical control element as shown in FIG. 4(c), and disposed on a parallax interleaved image 427. Since the optical apertures are disposed in an oblique direction, the same column on the parallax component image 426 is disposed generally in the vertical direction on the parallax interleaved image, but disposed obliquely in each part to meet the optical apertures. The parallax component images are disposed on the parallax interleaved image in an interleaved format to form an elemental image array.

### First Embodiment

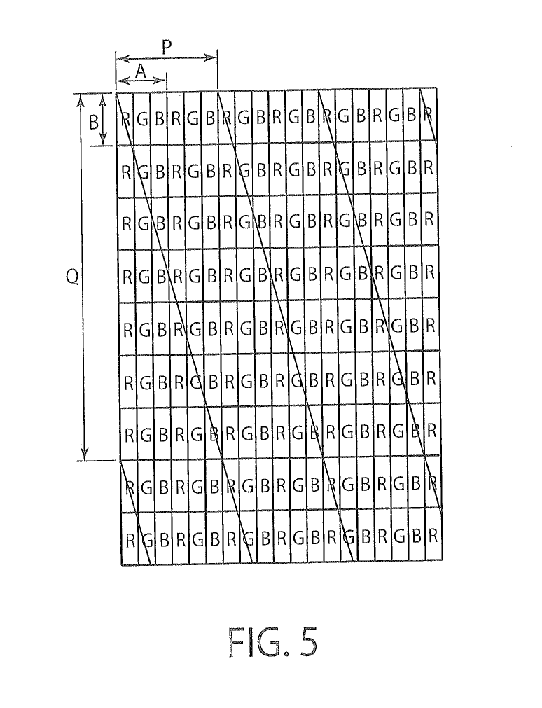

A three-dimensional video display apparatus according to a first embodiment has a structure in which an optical control element such as a lenticular, a barrier, or a pattern light source is disposed with inclination from the longitudinal direction of pixels, in front of or behind a display plane having pixels of a longitudinal stripe color filter arranged in a matrix form. An example of position relations between pixels and the optical control element which are used in the three-dimensional video display apparatus according to the present embodiment is shown in FIG. 5. FIG. 5 shows a region of 6.3 pixel columns×9 pixel rows. In FIG. 5, each oblique line represents an intermediate line of an optical aperture of the optical control element. In other words, in the case where the optical control element is a lens array, each oblique line represents a lens boundary. In the case where the optical control element is a slit array or a pattern light source, each oblique line represents an intermediate line of a slit or light source. Each pixel is divided into three sub-pixels respectively having three color components (R, G and B) arranged in the lateral direction.

Supposing that the optical control element is a lenticular (cylindrical lens array) and designating the number of color components by M (in FIG. 5, there are three components R, G and B, and consequently M=3), a pitch (longitudinal interval) of lenses in the longitudinal direction by Q, a pitch (longitudinal interval) of pixels in the longitudinal direction by B, a pitch (lateral interval) of lenses in the lateral direction by P, and a pitch (lateral interval) of pixels in the lateral direction by A, an inclination angle of lenses with respect to the pixel columns becomes

tan⁻¹(1/a) (1)

where a=(Q/B)/(P/A). If the number N of parallaxes satisfies the condition

N=Q/B, (2)

then the resolution of the three-dimensional video becomes 1/N (lateral 1/s, longitudinal 1/t) as compared with the resolution of the display plane, and the number of color components becomes M for each pixel of the three-dimensional video without excess and deficiency. Here, s and t are real numbers satisfying N=st. As for mapping for rearranging an input multiple viewpoint video to a video to be output to the display unit, the output a video have a period corresponding to N (=Q/B) pixels, with respect to the viewpoint number (the number of parallaxes) and coordinates of the multiple viewpoint video. As a result, the memory required for mapping becomes equivalent to only N rows. By the way, the mapping will be described in detail later.

In the example shown in FIG. 5, M=3, Q/B=7, and P/A=2. Therefore if the number N of parallaxes is 7, the number of color components becomes M for each pixel of the three-dimensional video without excess and deficiency and the memory required for mapping becomes equivalent to only 7 rows.

When conducting mapping to rearrange the multiple viewpoint video to a video to be output to the display unit, mapping with the number N′ of parallaxes is conducted in a first aspect of the present embodiment, where N is Q/B prescribed by the display plane of the display unit, and N′ is an integer satisfying the following Expression (3).

((M−1)/M)N−0.5≦N′<N (3)

Owing to such a configuration, a color component concerning the resolution (resolution concerning pixels of the three-dimensional video) is reduced slightly. However, one color is not lost completely. As compared with the case where mapping with N parallaxes is conducted, reduction of the number of pixels is improved from 1/N to 1/N′ and the degree of freedom in design is also improved. By the way, in Expression (3), the term of −0.5 means that N′ should be at least ((M−1)/M)N when rounded to the nearest whole number.

When conducting mapping to rearrange the multiple viewpoint video to a video to be output to the display unit, mapping with the number N′ of parallaxes is conducted in a second aspect of the present embodiment, where N is Q/B prescribed by the display plane of the display unit, and N′ is an integer satisfying the following Expression (4).

N<N′≦(M/(M−1))N+0.5 (4)

Owing to such a configuration, a color component concerning the parallax number is reduced slightly. However, one color is not lost completely. As compared with the case where mapping with N parallaxes is conducted, reduction of the number of pixels is increased from 1/N to 1/N′. Since the number of parallaxes can be increased, however, the area of the viewing zone or the projection depth range is improved and the degree of freedom in design is also improved. By the way, in Expression (4), the term of +0.5 means that N′ should be equal to or less than (M/(M−1))N when rounded to the nearest whole number.

The mapping will now be described.

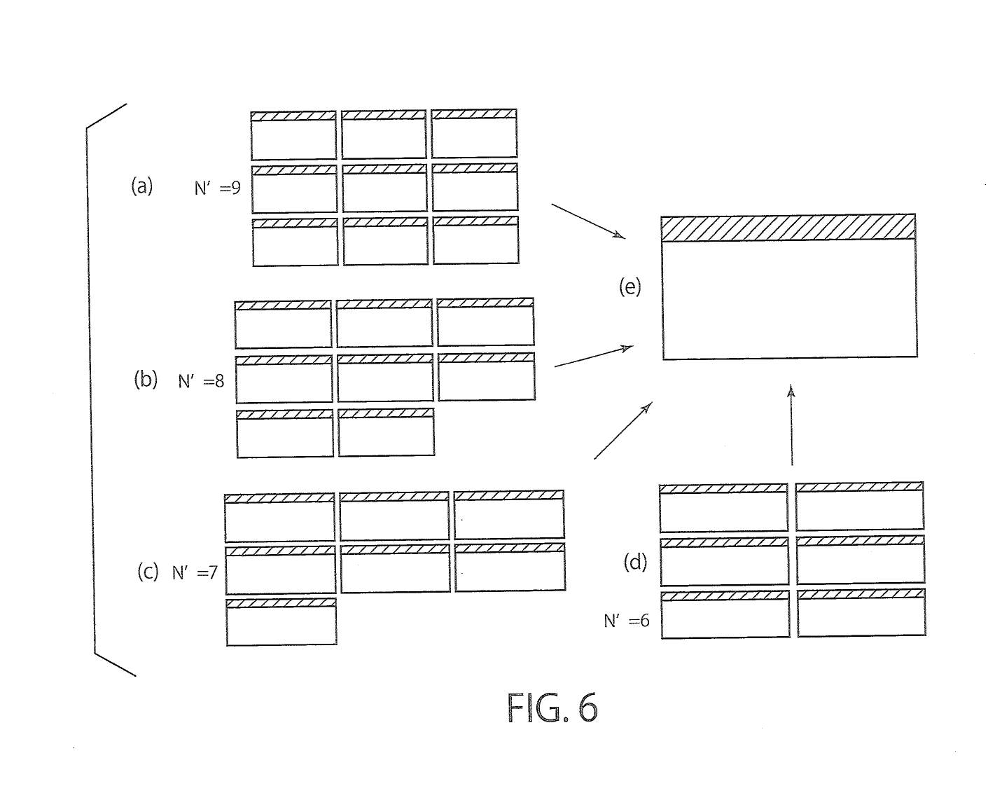

FIGS. 6(a) to 6(e) are schematic diagrams showing mapping in rearrangement processing from a multiple viewpoint video to an output video (to the display plane) used in the three-dimensional video display apparatus according to the present embodiment. A basic mapping method is similar to that in Japanese Patent No. 4476905 B1. If the number of pixels and sampling position of the multiple viewpoint video differ from those of the output video (to the display plane), resize processing is conducted. As a resize filter, simple sampling, linear interpolation, nonlinear interpolation or the like is used. For convenience of signal processing, the resolution of each viewpoint image (=resolution viewed as a three-dimensional video) is set to 1/N′ (lateral 1/u and longitudinal 1/v) as compared with the resolution of the output video to the display plane. In an example of N′=9 (u=v=3) shown in FIG. 6(a), three row shaded regions of the multiple viewpoint video having nine viewpoints shown in FIG. 6(a) are mapped to a nine row region of the output video shown in FIG. 6(e). The viewpoint number and coordinates of the multiple viewpoint video mapped to each sub-pixel of the output image are arranged with a period of nine rows. Since the mapping is conducted with the period of nine rows, the memory required for the mapping needs only a capacity corresponding to nine rows. By the way, the multiple viewpoint video of nine viewpoints may be generated by conducting conversion processing on a multiple viewpoint video of at least two viewpoints which is input.

In an example of N′=8 (u=8/3, v=3) and N=9 shown in FIG. 6(b), one row shaded regions of the multiple viewpoint video having eight viewpoints shown in FIG. 6(b) are mapped to an three row region of the output video shown in FIG. 6(e). The viewpoint number and coordinates of the multiple viewpoint video mapped to each sub-pixel of the output image are arranged with a period of nine rows. Since the mapping is conducted with the period of nine rows, the memory required for the mapping needs only a capacity corresponding to nine rows. By the way, the multiple viewpoint video of eight viewpoints may be generated by conducting conversion processing on a multiple viewpoint video of at least two viewpoints which is input.

In an example of N′=7 (u=7/3, v=3) and N=7 shown in FIG. 6(c), one row shaded regions of the multiple viewpoint video having seven viewpoints shown in FIG. 6(c) are mapped to a three row region of the output video shown in FIG. 6(e). The viewpoint number and coordinates of the multiple viewpoint video mapped to each sub-pixel of the output image are arranged with a period of seven rows. Since the mapping is conducted with the period of seven rows, the memory required for the mapping needs only a capacity corresponding to seven rows. By the way, the multiple viewpoint video of seven viewpoints may be generated by conducting conversion processing on a multiple viewpoint video of at least two viewpoints which is input.

In an example of N′=6 (u=2, v=3) and N=6 shown in FIG. 6(d), one row shaded regions of the multiple viewpoint video having six viewpoints shown in FIG. 6(d) are mapped to a three row region of the output video shown in FIG. 6(e). The viewpoint number and coordinates of the multiple viewpoint video mapped to each sub-pixel of the output image are arranged with a period of six rows. Since the mapping is conducted with the period of six rows, the memory required for the mapping needs only a capacity corresponding to six rows. By the way, the multiple viewpoint video of six viewpoints can be generated by conducting conversion processing on a multiple viewpoint video of at least two viewpoints which is input.

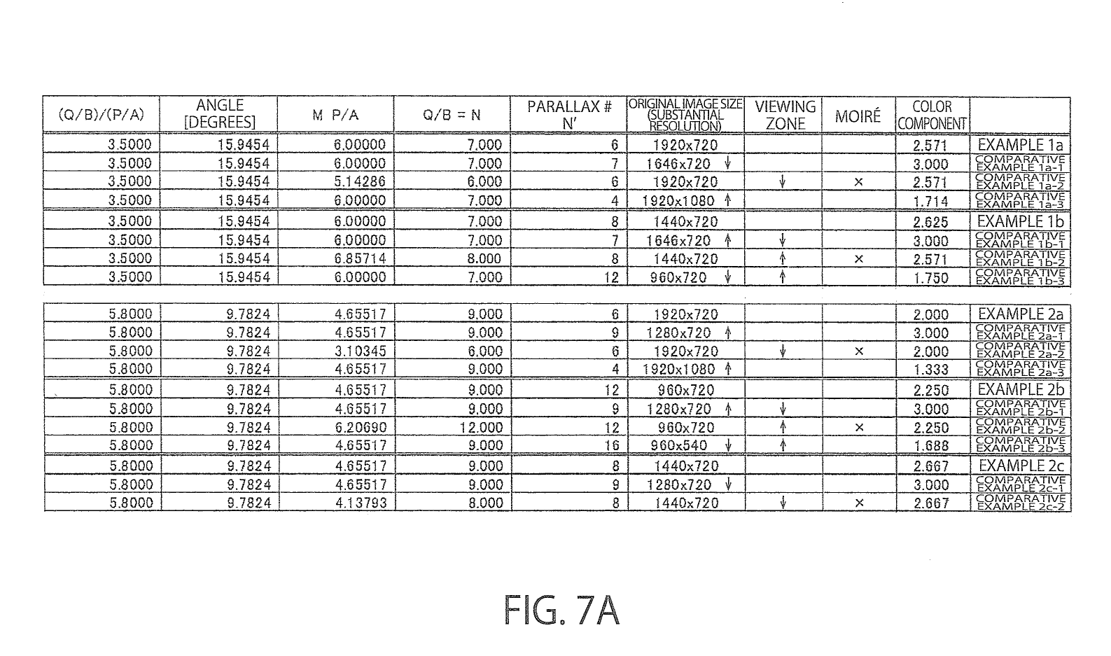

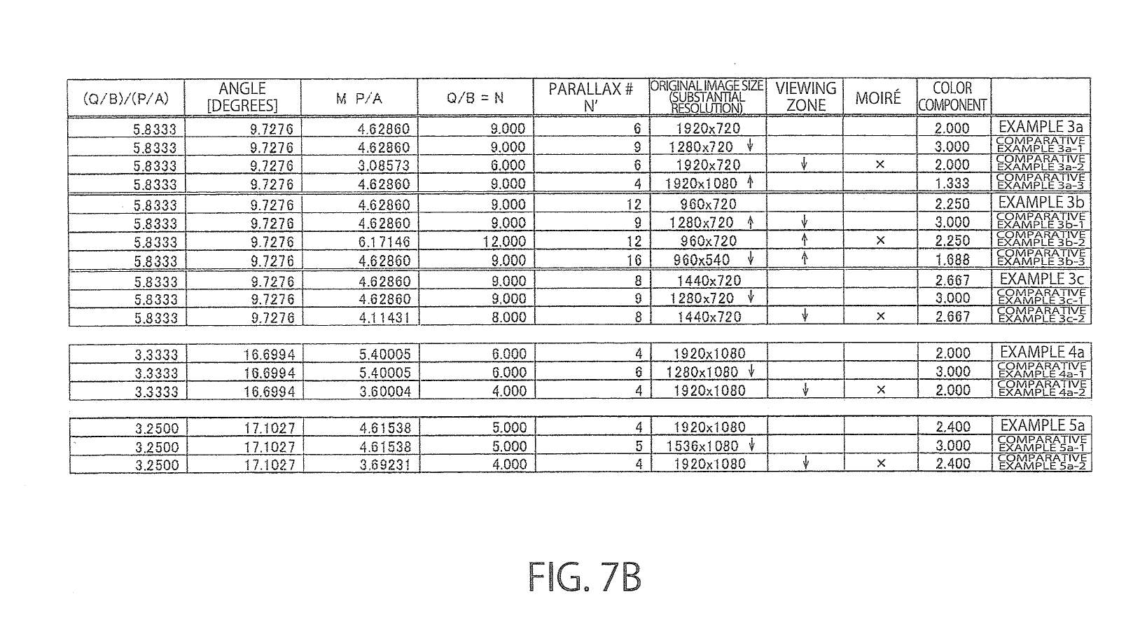

FIGS. 7A and 7B show examples of a combination of a relation of period between pixels and the optical control element ((Q/B)/(P/A)), an angle (inclination angle) of the optical control element with respect to a pixel column direction (second direction), Q/B, the number of mapped parallaxes N′, and an original image size, which are used in a three-dimensional video display apparatus according to the present embodiment, and a viewing zone, whether there is moiré, and the number of color components in each case. In a column of “substantial resolution” shown in FIGS. 7A and 7B, a symbol “↓” means that the substantial resolution becomes lower as compared with a corresponding example whereas a symbol “↑” means that the substantial resolution becomes higher as compared with the corresponding example. For example, a comparative example 1a-1 becomes lower in substantial resolution than an example 1a, whereas a comparative example 1a-3 becomes higher in substantial resolution than the example 1a. In a column of “viewing zone,” a symbol “↓” means that the viewing zone is narrower as compared with a corresponding example whereas a symbol “↑” means that the viewing zone is wider as compared with the corresponding example. In a column of “moiré,” a symbol “×” means that moiré is apt to occur. For example, in a comparative example 1a-2, the viewing zone is narrower and moiré is more apt to occur as compared with the corresponding example 1a.

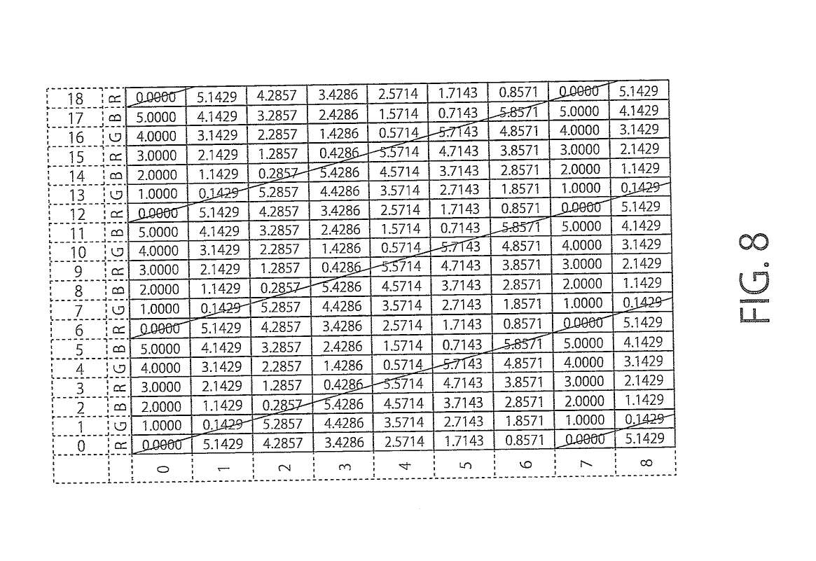

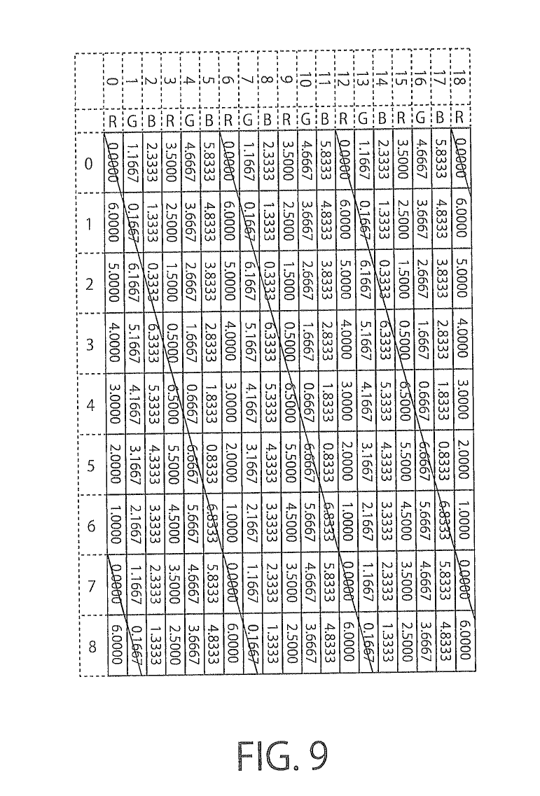

As the number N′ of parallaxes becomes less than Q/B (=N), the resolution of each viewpoint image (original image) can be made high and a drop of the resolution of the three-dimensional video can be restricted to 1/N′ (lateral 1/u and longitudinal 1/v) as shown in FIGS. 7A and 7B. Here, u and v are real numbers satisfying N′=uv. However, there are only bM/N color components with respect to the number b of display pixels. If bM/N color components are assigned to b/N′ pixels, the number of color components for each pixel of the three-dimensional video becomes (N′/N)M. If N′ is at least ((M−1)/M)N, then the number of color components is at least (M−1) and consequently one color component is not lost completely, little problem being posed in display. An example in which design and mapping are conducted in this way is the example is shown in FIG. 8, and reduction in the number of pixels can be suppressed as compared with mapping of the comparative example 1a-1 shown in FIG. 9.

FIG. 8 and FIG. 9 are diagrams showing examples of position relations between pixels and the optical control element and mapping of parallax number (viewpoint number) assigned to each sub-pixel, which are used in three-dimensional video display apparatuses according to the example 1a and the comparative example 1a-1, respectively. The inclination angle and pitch of the optical control element are the same as those in FIG. 5. A region corresponding to one optical aperture (a region between two parallel oblique lines) is assigned a parallax number in the region of 0 to 6 in FIG. 8 and in the region of 0 to 7 in FIG. 9 in proportion to the distance from the oblique line. If a parallax number assigned to a sub-pixel is an integer, then a pixel only from a video of a single viewpoint in the multiple viewpoint video is mapped and assigned. If a parallax number which is not an integer is assigned, then pixels from a video of two adjacent viewpoints in the multiple viewpoint video are averaged according to a ratio of numerals of parallax numbers and assigned.

In the case of the comparative example 1a-2 (N=N′=6), there are harmful effects such as a shortened lens pitch, a reduced viewing zone or projection quantity, a slant stripe in color array of three-dimensional video, and occurrence of moiré.

In the case of the comparative example 1a-3 (N′=4), the resolution becomes higher. However, the number of color components becomes less than 2 and loss of color components is great. By the way, any of the comparative examples 1a-1, 1a-2 and 1a-3 does not satisfy Expression (3).

If the number N′ of parallaxes is greater than Q/B (=N), then lowering of the resolution of the three-dimensional video becomes as great as 1/N′ (lateral 1/u, longitudinal 1/v, N′=uv) and the number of color components becomes (N/N′)M for each parallax component of each pixel of the three-dimensional video, If N′ is (M/(M−1))N or less, then the number of color components is at least (M−1) and one color component is not lost completely, little problem being posed in display. An example in which design and mapping are conducted in this way is an example 1b shown in FIG. 8, and the viewing zone can be expanded as compared with a comparative example 1b-1.

In case of a comparative example 1b-2 (N=N′=8), the lens pitch becomes longer and the viewing zone or the projection quantity is improved. However, there are harmful effects such as a slant stripe in color array of three-dimensional video, and occurrence of moiré.

In case of a comparative example 1b-3 (N′=12), the viewing zone becomes wider. However, the resolution falls, and loss of color components is great and becomes 2 or less for M=3. Any of the comparative example 1b-1, the comparative example 1b-2, and the comparative example 1b-3 does not satisfy Expression (4).

As a matter of fact, design restrictions on the lens angle and pitch are great for the purpose of eliminating moiré. Owing to “condition relaxation” according to the present embodiment, the degree of freedom of design is also improved. It becomes easy to set the number of parallaxes equal to a rounded out number which is convenient to image processing such as, for example, 4, 6, or 9 parallaxes, i.e., a multiple of 2 or a multiple of M. Therefore, the degree of freedom in design is improved.

If mapping of N′ parallaxes satisfying the condition represented by Expression (3) ((M−1)/M)N−0.5 N′<N) is conducted in this way in the lens design of N parallaxes, then a color component concerning the resolution (pixel of the three-dimensional video) is reduced slightly. However, one color is not lost completely. As compared with the case where mapping of N parallaxes is conducted, reduction in the number of pixels is improved from 1/N to 1/N′ and the degree of freedom in design is also improved.

Furthermore, if mapping of N′ parallaxes satisfying the condition represented by Expression (4) (N<N′≦(M/(M−1))N+0.5) is conducted in the lens design of N parallaxes, then a color component concerning the parallax number is reduced slightly. However, one color is not lost completely. As compared with the case where mapping of N parallaxes is conducted, reduction in the number of pixels is increased from 1/N to 1/N′. Since the number of parallaxes can be increased, however, the area of the viewing zone is improved and the degree of freedom in design is also improved.

Although examples 2a, 2b, 2c, 3a, 3b, 3c, 4a and 5a are examples which differ from the examples 1a and 1b in lens inclination and pitch, similar effects can be obtained. Any of comparative examples 2a-1, 2a-2, 2a-3, 3a-1, 3a-2, 3a-3, 3c-1, 3c-2, 4a-1, 4a-2, 5a-1 and 5a-2 does not satisfy Expression (3). Any of comparative examples 2b-1, 2b-2, 2b-3, 3b-1, 3b-2 and 3b-3 does not satisfy Expression (4).

By the way, for suppressing occurrence of moiré, it is desirable that the lens inclination and the periodicity of the pitch are low to some extent. For that purpose, it is desirable that (Q/B)/(P/A) is not an integer. Furthermore, it is desirable that M×P/A is not an integer.

According to the present embodiment and the examples, reduction in the number of pixels is suppressed and the degree of freedom in design is improved, as described heretofore.

While certain embodiments have been described, these embodiments have been presented by way of example only, and are not intended to limit the scope of the inventions. Indeed, the novel methods and systems described herein can be embodied in a variety of other forms; furthermore, various omissions, substitutions and changes in the form of the methods and systems described herein can be made without departing from the spirit of the inventions. The accompanying claims and their equivalents are intended to cover such forms or modifications as would fail within the scope and spirit of the inventions.

What is claimed is:

1. A three-dimensional video display apparatus comprising:
a display unit having pixels arranged in a matrix form along a first direction and a second direction perpendicular to the first direction, each of the pixels being divided into M sub-pixels respectively having M color components arranged in the first direction, M being an integer of at least 1;
an optical control element installed opposite to the display unit, the optical control element functioning as a plurality of optical apertures extended in a straight line manner at a constant angle from the second direction and arranged in the first direction; and
a driving circuit which conducts mapping of rearranging a multiple viewpoint video having a number N′ of viewpoints to a video to be output to the display unit, N′ being an integer satisfying
((M−1)/M)N−0.5≦N′<N
or
N<N′≦(M/(M−1))N+0.5,
N being equal to Q/B, Q being an interval of the optical apertures in the second direction, and B being an interval of the pixels in the second direction.

2. The three-dimensional video display apparatus according to claim 1, wherein designating a period of the optical apertures in the first direction by P and a period of the pixels in the first direction by A, (Q/B)/(P/A) is not an integer.

3. The three-dimensional video display apparatus according to claim 2, wherein MP/A is not an integer.

4. The three-dimensional video display apparatus according to claim 1, wherein N′ is a multiple of 2 or a multiple of M.

5. The three-dimensional video display apparatus according to claim 1, wherein M is 3.

6. A three-dimensional video display method for displaying a three-dimensional video by using a three-dimensional video display apparatus including a display unit having pixels arranged in a matrix form along a first direction and a second direction perpendicular to the first direction, each of the pixels being divided into M sub-pixels respectively having M color components arranged in the first direction, M being an integer of at least 1, and an optical control element installed opposite to the display unit, the optical control element functioning as a plurality of optical apertures extended in a straight line manner at a constant angle from the second direction and arranged in the first direction,
the three-dimensional video display method comprising a step of conducting mapping of rearranging a multiple viewpoint video having a number N′ of viewpoints to a video to be output to the display unit, N′ being an integer satisfying
((M−1)/M)N−0.5≦N′<N
or
N<N′≦(M/(M−1))N+0.5,
N being equal to Q/B, Q being an interval of the optical apertures in the second direction, and B being an interval of the pixels in the second direction.
